(19) United States
(12) Patent Application Publication
(10) Pub. No.: US 2008/0157597 A1
(43) Pub. Date: Jul. 3, 2008

(54) Multiple output isolated converter circuit

(76) Inventors: Annabelle Pratt, Hillsboro, OR (US); Pavan Kumar, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/646,011

(22) Filed: Dec. 27, 2006

(51) Int. Cl. H02J 1/00

(52) U.S. Cl. 307/31

(57) ABSTRACT

In some embodiments, an N output isolated converter includes an isolated converter circuit having N+1 switch circuits, the isolated converter circuit being configured to receive an input voltage and to provide N output voltages, where N is two or more, and a control circuit to selectively provide control signals to the N+1 switch circuits at time intervals in accordance with the N output voltages. The N output isolated converter may include a single secondary transformer. Other embodiments are disclosed and claimed.

The invention relates to isolated converters and more particularly to an N+1 switch N output isolated converter, where N is two or more, and where the isolated converter includes a single secondary transformer.

### BACKGROUND AND RELATED ART

Voltage converters are well known in the art. A typical power delivery system for a computing platform may include loads requiring legacy voltages (e.g. 12V, 5V and 3.3V) as well as loads requiring silicon level voltages (e.g. which may range from about 1V to about 2.5V). For example, the legacy voltages may be generated from an isolated multi-output DC/DC converter within the Power Supply Unit (PSU). For example, the lower silicon voltages may be generated by stepping down the legacy voltages using Voltage Regulators (VRs). Some conventional isolated multi-output DC/DC converters may require a high number of semiconductor switches to generate the separate outputs. Some conventional isolated multi-output DC/DC converters may also require complex transformers with multiple secondary windings, potentially leading to higher cost implementations. In some applications, lower quality components may be used to offset increased cost, which may compromise efficiency.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram in accordance with some embodiments of the present invention.

FIG. 2 is another block diagram in accordance with some embodiments of the present invention.

FIG. 3 is a schematic diagram in accordance with some embodiments of the present invention.

FIG. 4 is a current flow diagram in accordance with some embodiments of the present invention.

FIG. 5 is another current flow diagram in accordance with some embodiments of the present invention.

FIG. 6 is another current flow diagram in accordance with some embodiments of the present invention.

FIG. 7 is another schematic diagram in accordance with some embodiments of the present invention.

FIG. 8 is another schematic diagram in accordance with some embodiments of the present invention.

FIG. 9 is a flow diagram in accordance with some embodiments of the present invention.

FIG. 10 is a block diagram of a system in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

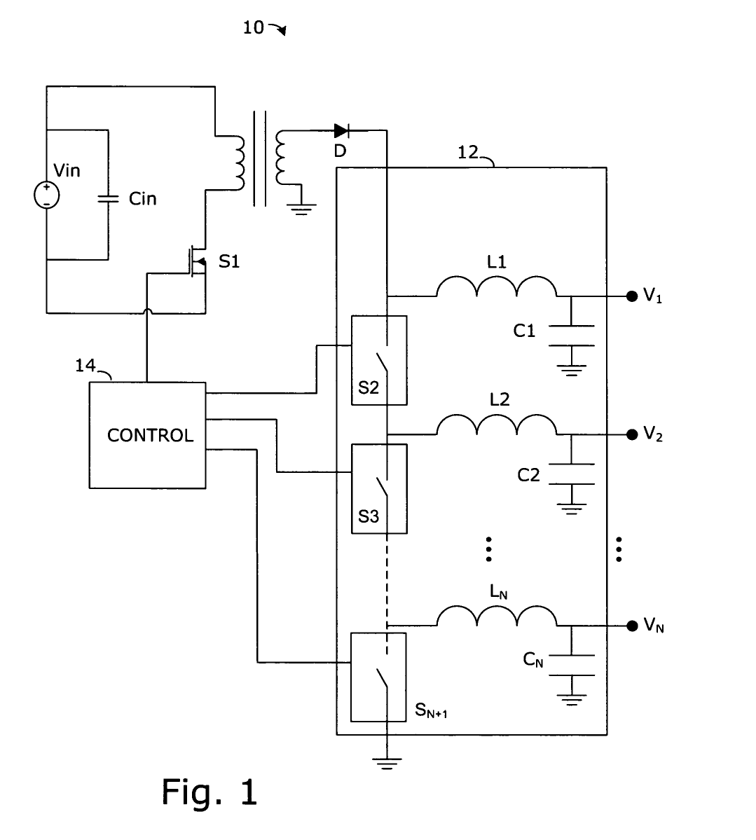

With reference to FIG. 1, a voltage converter 10 may include an isolated converter circuit which may have no more than N+1 switch circuits S1 through S_{N+1}. The isolated converter circuit may be configured to receive an input voltage V_{IN} and may provide N output voltages V₁ through V_{N}, where N is two or more, and a control circuit 14 to selectively provide control signals to the N+1 switch circuits S1 through S_{N+1} at time intervals in accordance with the N output voltages V₁ through V_{N}. The isolated converter circuit may include a single secondary transformer. In general, each successive output voltage may be equal to or less than the prior output voltage (e.g. V₁≧V₂≧ . . . V_{N}) For example, two switch circuits (e.g. S1 and S2) may be utilized to produce a first output voltage (e.g. V₁) of the N output voltages and only one additional switch circuit (e.g. S3 through S_{N+1}) may be provided for each additional output voltage (e.g. V₂ through V_{N}) of the N output voltages. The voltage converter 10 may be considered to have an isolated cascaded buck converter topology that utilizes semiconductor switches in an improved manner such that the number of switches may be reduced.

In some embodiments, the isolated converter circuit may include a first switch circuit S1 in an input section. An output section 12 may include a second switch circuit S2 and a third switch circuit S3 coupled in series between a diode D, coupled to an output of the input section, and the ground potential. The output section 12 may further include a first LC circuit (e.g. L1 and C1) coupled to one side of the second switch circuit S2 and a second LC circuit (e.g. L2 and C2) coupled to a junction of the second and third switch circuits S2, S3. The first LC circuit may be configured to provide a first output voltage V₁ and the second LC circuit may be configured to provide a second output voltage V₂, which is a different magnitude from the first output voltage V₁.

For example, the control circuit 14 may be configured to turn on the first and second switch circuits S1, S2 and turn off the third switch circuit S3 during a first interval of a period of a switching cycle. The control circuit 14 may be further configured to turn on the first and third switch circuits S1, S3 and turn off the second switch circuit S2 during a second interval of the same period of the switching cycle. The control circuit 14 may be further configured to turn on the second and third switch circuits S2, S3 and turn off the first switch circuit S1 during a third interval of the same period of the switching cycle. More intervals and switch configurations may be utilized during the switching interval to provide all of the needed output voltages for each cascaded stage.

Further details regarding the construction and operation of N+1 switch, N output converter circuits may be had with reference to related U.S. patent application Ser. No. 11/158,576, filed Jun. 21, 2005, and entitled MULTIPLE OUTPUT BUCK CONVERTER.

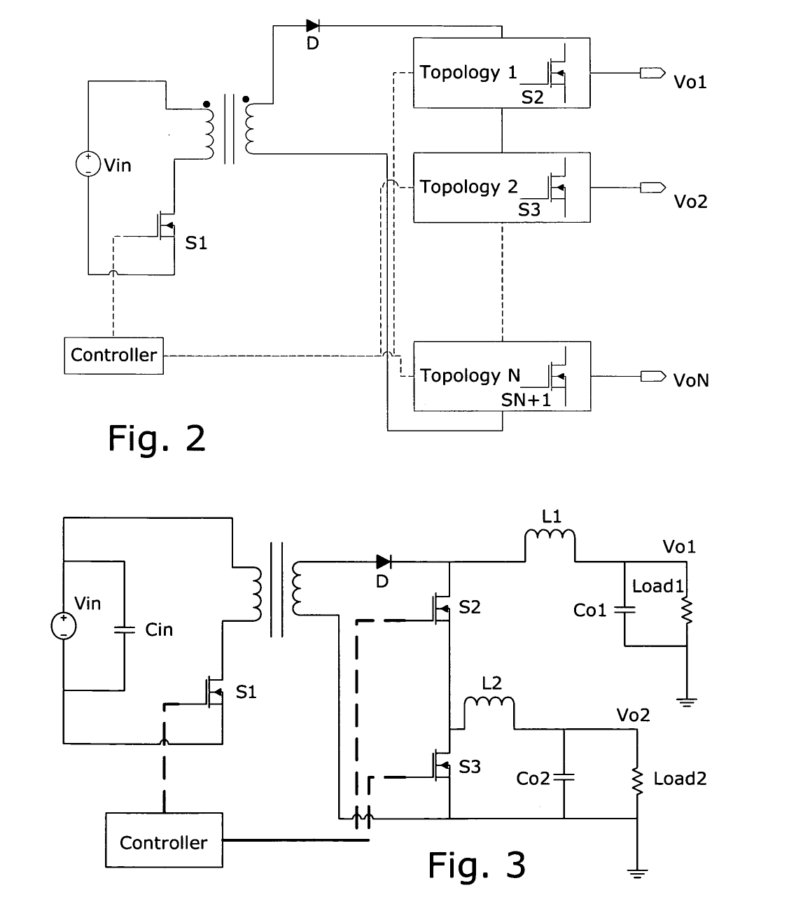

With reference to FIG. 2, a voltage converter 20 may include an isolated converter circuit which may have N+1 switch circuits S1 through S_{N+1}. The isolated converter circuit may be configured to receive an input voltage V_{IN} and may provide N output voltages V₁ through V_{N}, where N is two or more, and a control circuit 22 to selectively provide control signals to the N+1 switch circuits S1 through S_{N+1} at time intervals in accordance with the N output voltages V₁ through V_{N}, where the N output voltages include at least two different types of outputs. The isolated converter circuit may include a single secondary transformer. As used herein, a different type of output refers to an output from a different class of voltage converter, and not simply a different magnitude of output voltage.

For example, the switch circuits S1 through S_{N+1} may be coupled to respective voltage converter topologies 1 through N, where at least one topology is different from at least one other topology. For example, Topology 1 may include a boost converter topology and Topology 2 may include a buck converter topology such that at least one of the N output voltages includes a boost output and at least one of the N output voltages includes a buck output. Those skilled in the art will appreciate that a variety of switch and topology configurations are within the scope and spirit of the invention. For example, the switches may be re-configured such that Topology 1 may include a buck-boost converter topology and Topology 2 may include a buck converter topology such that at least one of the N output voltages includes a buck-boost output and at least one of the N output voltages includes a buck output. Given the teachings of the present specifications, other configurations and topologies may readily be implemented by those skilled in the art.

In general, each successive output voltage may be equal to or less than the prior output voltage (e.g. V₁≧V₂≧ . . . V_{N}) For example, two switch circuits (e.g. S1 and S2) may be utilized to produce a first output voltage (e.g. V₁) of the N output voltages and only one additional switch circuit (e.g. S3 through S_{N+1}) may be provided for each additional output voltage (e.g. V₂ through V_{N}) of the N output voltages. The voltage converter 10 may be considered to have a cascaded converter topology that utilizes semiconductor switches in an improved manner such that the number of switches may be reduced.

In some embodiments, a first switch circuit S1 may be provided in an input section. An output section 21 may include a first voltage converter circuit 23 coupled to an output of the input section, where the first voltage converter circuit 23 is configured to provide a first type of output voltage V₁. At least a diode D, a second converter circuit 24 containing switch circuit S2 and a third converter circuit 25 containing switch circuit S3 may be coupled in series between the outputs of the input section. The converter circuits may also contain other circuitry (e.g. an LC circuit). Converter circuit 24 may be coupled in series with circuits 23 and 25, where the converter circuit 24 is configured to provide a second type of output voltage, different from the first type of output voltage. Additional converter circuit(s) 25 containing successive switch circuits through switch S_{N+1} may be coupled in series.

For example, the control circuit 22 may be configured, in a two interval mode, to turn on the second switch circuit S2 and turn off the first and third switch circuits S1, S3 during a first interval of a period of a switching cycle; and to turn on the first and third switch circuits S1, S3 and turn off the second switch circuit S2 during a second interval of the same period of the switching cycle. Alternatively, the control circuit 22 may be configured, in a three interval mode, to turn on the second and third switch circuits S2, S3 and turn off the first switch circuit S1 during a first interval of a period of the switching cycle; to turn on the second switch circuit S2 and turn off the first and third switch circuits S1, S3 during a second interval of the same period of the switching cycle; and to turn on the first and third switch circuits S1, S3 and turn off the second switch circuit S2 during a third interval of the same period of the switching cycle. More intervals and switch configurations may be utilized during the switching interval to provide all of the needed output voltages for each cascaded stage.

Of course, various embodiments of the present invention may or may not be better suited for various power applications. Some embodiments of the voltage converter of the present invention may be particularly well suited to provide the many voltage rails on a PC platform. For example, one or more N+1 switch, N output, multiple topology converters, according to some embodiments of the invention, may replace the DC/DC converter in the power supply on a computing platform.

Further details regarding the construction and operation of multiple output, multiple topology converter circuits may be had with reference to related U.S. patent application Ser. No. 11/524,676, filed Sep. 21, 2006, and entitled MULTIPLE OUTPUT MULTIPLE TOPOLOGY VOLTAGE CONVERTER.

With reference to FIG. 3, an example three switch dual output isolated buck converter, according to some embodiments of the invention, includes three switches S1, S2, and S3 to provide two voltage outputs V₁ and V₂. Transformer reset circuits are not shown, but similar circuits to those developed for conventional isolated converters may be used where necessary or desirable. The switch S1 selectively provides a ground path for the primary transformer. The two switches S2 and S3 are connected in series between the diode D, which is coupled to the secondary transformer output voltage, and ground. A first LC circuit is connected to the junction between the diode D and S2. A second LC circuit is connected to the junction between S2 and S3. The first LC circuit provides the first output voltage V₁ at the junction of the inductor L1 and the capacitor C1. The second LC circuit provides the second output voltage V₂ at the junction of the inductor L2 and the capacitor C2. In general, V₁ will be greater than V₂. In most applications, providing two or more different output voltages is a desirable feature.

Of course, various embodiments of the present invention may or may not be better suited for various power applications. Some embodiments of the voltage converter of the present invention may be particularly well suited to provide the many voltage rails on a PC platform. For example, one or more N+1 switch, N output isolated buck converters, according to some embodiments of the invention, may replace the DC/DC converter in the power supply on a computing platform.

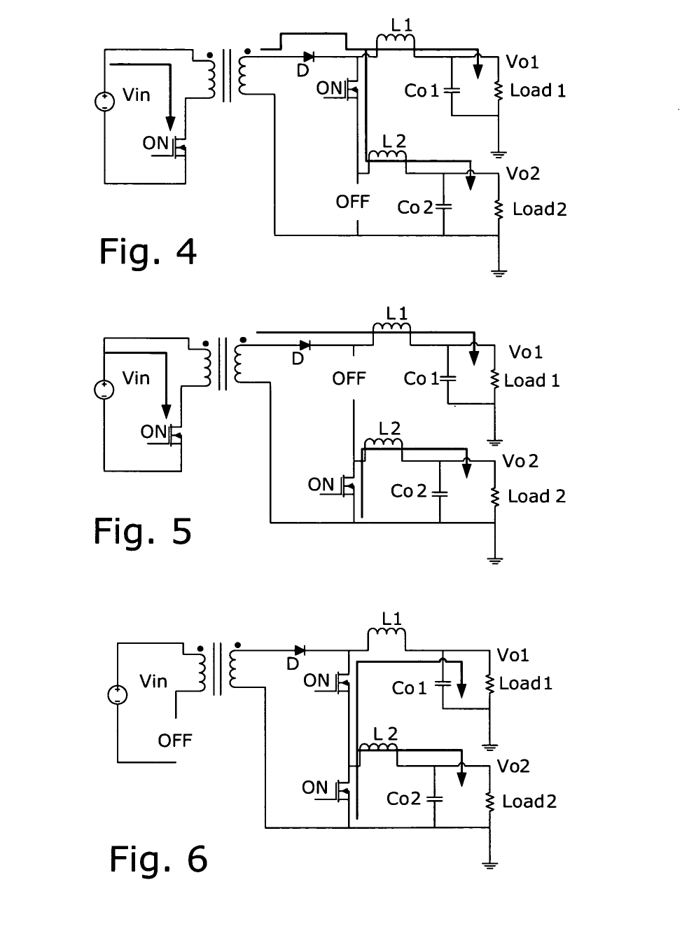

With reference to FIG. 4, in a first interval the switches S1 and S2 may be turned ON (closed) and the switch S3 may be turned OFF (open). Under these conditions, the inductor currents I_{L1} and I_{L2} may be ramped directly from the secondary transformer output voltage.

With reference to FIG. 5, at the end of the first interval, in a second interval the switch S1 may continue to be ON, the switch S2 may be turned OFF (open), and the switch S3 may be turned ON (closed). In the second interval, the current I_{L1} in the inductor L1 continues to ramp up, but the current I_{L2} in the inductor L2 starts ramping down since the voltage across the inductor L2 is reversed with the switch S3 closed. The switch S2 may be reverse biased with substantially no current flowing through the switch S2.

With reference to FIG. 6, after the second interval, in a third interval the switch S1 may be turned OFF (open), the switch S2 may be turned ON (closed), and the switch S3 may continue to be ON (closed). Under these conditions, the inductor currents I_{L1} and I_{L2} may continue to flow in the positive direction through the ground, S2, and S3 paths as shown in FIG. 6.

Alternatively, some embodiments of the isolated converter circuit may operate in a two interval mode, as is described in the above-mentioned related application entitled MULTIPLE OUTPUT BUCK CONVERTER. Other enhancements, such as the use of coupled inductors in the 2-interval mode may also be applicable to the isolated converter circuit in some embodiments.

Conventional isolated multi-output DC/DC converters may require a high number of semiconductor switches to generate the separate outputs, and may also require complex transformers with multiple secondary windings. Some embodiments of the present invention may provide a class of isolated multi-output DC/DC converters requiring fewer semiconductor switches than a conventional converter, as well as being able to use transformers with a single secondary. Advantageously, some embodiments of the invention may provide a multi-output isolated converter at lower cost than conventional converters.

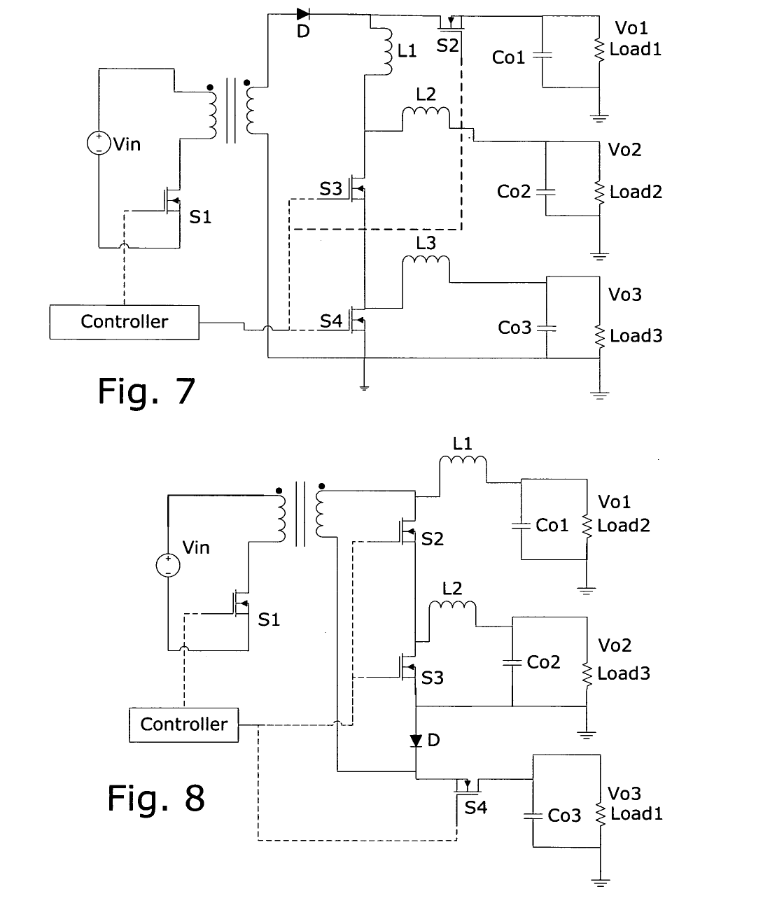

With reference to FIGS. 7 and 8, some embodiments of the present invention may be extended to isolated converters with multiple output topologies. For example, FIG. 7 shows an embodiment of a multiple output isolated converter circuit having both a buck topology and a boost topology. FIG. 8 shows an embodiment of a multiple output isolated converter circuit having both a buck topology and a buck-boost topology. For example, an advantage of the isolated buck and buck-boost converter according to some embodiments of the invention is that positive and negative outputs can be realized with a single secondary transformer.

Advantageously, various embodiments of the invention may provide one or more of the following benefits as compared to conventional circuits to provide multiple isolated, regulated outputs:
individually regulated outputs with much lower component count and simpler transformers;
multiple voltage rails in a more compact space due to lower component count, allowing for higher density designs;
an inexpensive solution due to lower component count and simpler transformers;
improvement in the overall efficiency since individually regulated outputs can be achieved in a single stage;
reduced or minimized control requirements compared to other topologies providing individually regulated outputs.

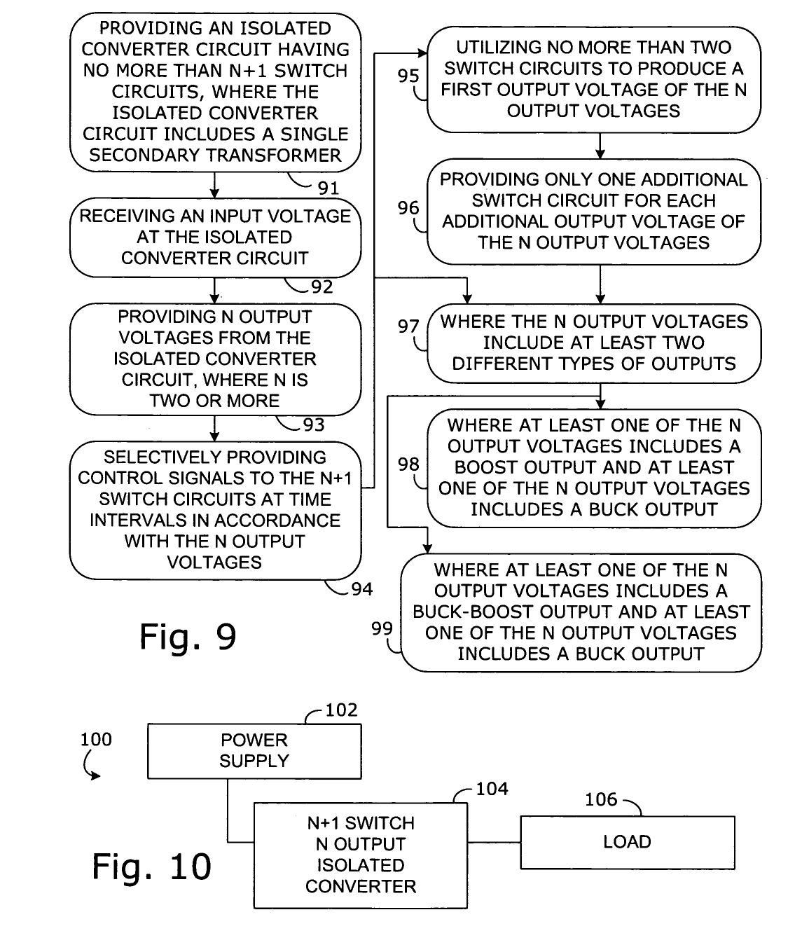

With reference to FIG. 9, some embodiments of the invention may involve providing an isolated converter circuit having N+1 switch circuits, where the isolated converter circuit includes a single secondary transformer (e.g. at 91), receiving an input voltage at the isolated converter circuit (e.g. at 92), providing N output voltages from the isolated converter circuit, where N is two or more (e.g. at 93), and selectively providing control signals to the N+1 switch circuits at time intervals in accordance with the N output voltages (e.g. at 94).

For example, some embodiments may further involve utilizing no more than two switch circuits to produce a first output voltage of the N output voltages (e.g. at 95), and providing only one additional switch circuit for each additional output voltage of the N output voltages (e.g. at 96). In some embodiments, the N output voltages may include at least two different types of outputs (e.g. at 97). For example, at least one of the N output voltages may include a boost output and at least one of the N output voltages may include a buck output (e.g. at 98). Alternatively, at least one of the N output voltages may include a buck-boost output and at least one of the N output voltages may include a buck output (e.g. at 99).

In some embodiments, providing the converter circuit may include providing a first switch circuit, a second switch circuit, and a third switch circuit coupled in series between the input voltage and the ground potential, providing a first LC circuit coupled to one side of the second switch circuit, the first LC circuit configured to provide a first output voltage, and providing a second LC circuit coupled to a junction of the second and third switch circuits, the second LC circuit configured to provide a second output voltage, with a different magnitude from the first output voltage.

A method of operation, according to some embodiments of the invention, may include turning on the first and second switch circuits and turning off the third switch circuit during a first interval of a period of a switching cycle, turning on the first and third switch circuits and turning off the second switch circuit during a second interval of the same period of the switching cycle, and/or turning on the second and third switch circuits and turning off the first switch circuit during a third interval of the same period of the switching cycle.

With reference to FIG. 10, an electronic system 100 includes a power supply 102 providing power to an N+1 switch N output isolated converter 104 (e.g. a three switch dual output isolated buck converter), where N is two or more. For example, the power supply may include an AC/DC converter or a battery configured to provide the input voltage to the isolated converter 104. The output of the isolated converter 104 may be provided to a load 106, which may utilize two or more output voltages from the isolated converter 104. For example, the load may include one or more integrated circuits (e.g. a processor and a memory), hard disk drives, voltage regulators and DC/DC converters.

The isolated converter 104 may have one or more of the features described above in connection with FIGS. 1-9. For example, the isolated converter 104 may include an isolated converter circuit having N+1 switch circuits, the isolated converter circuit being configured to receive an input voltage and to provide N output voltages, where N is two or more, and a control circuit to selectively provide control signals to the N+1 switch circuits at time intervals in accordance with the N output voltages, wherein one of the N output voltages is provided to a voltage regulator. The isolated converter 104 may include a single secondary transformer.

In some embodiments of the system 100, two switch circuits may be utilized to produce a first output voltage of the N output voltages and only one additional switch circuit may be provided for each additional output voltage of the N output voltages. For example, for a three switch dual output isolated converter, the converter circuit may include a first switch circuit in an input section, and an output section including a second switch circuit and a third switch circuit coupled in series between the output of the input section and the ground potential. The converter circuit may further include a first LC circuit coupled to one side of the second switch circuit and a second LC circuit coupled to a junction of the second and third switch circuits. The first LC circuit may be configured to provide a first output voltage and the second LC circuit may be configured to provide a second output voltage, different from the first output voltage.

In some embodiments of the system 100, the N output voltages may include at least two different types of outputs. For example, at least one of the N output voltages may include a boost output and at least one of the N output voltages may include a buck output. For example, at least one of the N output voltages may include a buck-boost output and at least one of the N output voltages may include a buck output.

Those skilled in the art will appreciate that many different hardware and/or software arrangements may be configured to provide appropriate control signals to the switching elements. For example, a processor or a micro-controller may readily be programmed to output waveforms with appropriate timing relationships. Alternatively, a discrete hardware circuit may be configured with various time constants to provide the control signals with appropriate timing relationships.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
an isolated converter circuit having no more than N+1 switch circuits, the isolated converter circuit being configured to receive an input voltage and to provide N output voltages, where N is two or more; and
a control circuit to selectively provide control signals to the N+1 switch circuits at time intervals in accordance with the N output voltages,
wherein the isolated converter circuit includes a single secondary transformer.

2. The apparatus of claim 1, wherein no more than two switch circuits are utilized to produce a first output voltage of the N output voltages and wherein only one additional switch circuit is provided for each additional output voltage of the N output voltages.

3. The apparatus of claim 2, wherein the N output voltages include at least two different types of outputs.

4. The apparatus of claim 3, wherein at least one of the N output voltages includes a boost output and at least one of the N output voltages includes a buck output.

5. The apparatus of claim 3, wherein at least one of the N output voltages includes a buck-boost output and at least one of the N output voltages includes a buck output.

6. The apparatus of claim 1, wherein the N output voltages include at least two different types of outputs.

7. The apparatus of claim 6, wherein at least one of the N output voltages includes a boost output and at least one of the N output voltages includes a buck output.

8. The apparatus of claim 6, wherein at least one of the N output voltages includes a buck-boost output and at least one of the N output voltages includes a buck output.

9. A method, comprising:
providing an isolated converter circuit having no more than N+1 switch circuits, wherein the isolated converter circuit includes a single secondary transformer;
receiving an input voltage at the isolated converter circuit;
providing N output voltages from the isolated converter circuit, where N is two or more; and
selectively providing control signals to the N+1 switch circuits at time intervals in accordance with the N output voltages.

10. The method of claim 9, further comprising:
utilizing no more than two switch circuits to produce a first output voltage of the N output voltages; and
providing only one additional switch circuit for each additional output voltage of the N output voltages.

11. The method of claim 10, wherein the N output voltages include at least two different types of outputs.

12. The method of claim 11, wherein at least one of the N output voltages includes a boost output and at least one of the N output voltages includes a buck output.

13. The method of claim 11, wherein at least one of the N output voltages includes a buck-boost output and at least one of the N output voltages includes a buck output.

14. The method of claim 9, wherein the N output voltages include at least two different types of outputs.

15. The method of claim 14, wherein at least one of the N output voltages includes a boost output and at least one of the N output voltages includes a buck output.

16. The method of claim 14, wherein at least one of the N output voltages includes a buck-boost output and at least one of the N output voltages includes a buck output.

17. A system, comprising:
a voltage regulator;
an isolated converter circuit having no more than N+1 switch circuits, the isolated converter circuit being configured to receive an input voltage and to provide N output voltages, where N is two or more; and
a control circuit to selectively provide control signals to the N+1 switch circuits at time intervals in accordance with the N output voltages,
wherein one of the N output voltages is provided to the voltage regulator
and wherein the isolated converter circuit includes a single secondary transformer.

18. The system of claim 17, wherein no more than two switch circuits are utilized to produce a first output voltage of the N output voltages and wherein only one additional switch circuit is provided for each additional output voltage of the N output voltages.

19. The system of claim 18, wherein the N output voltages include at least two different types of outputs.

20. The system of claim 18, wherein at least one of the N output voltages includes a boost output and at least one of the N output voltages includes a buck output.

21. The system of claim 18, wherein at least one of the N output voltages includes a buck-boost output and at least one of the N output voltages includes a buck output.

22. The system of claim 17, wherein the N output voltages include at least two different types of outputs.

23. The system of claim 22, wherein at least one of the N output voltages includes a boost output and at least one of the N output voltages includes a buck output.

24. The system of claim 22, wherein at least one of the N output voltages includes a buck-boost output and at least one of the N output voltages includes a buck output.

25. The system of claim 17, further comprising:
a battery configured to provide the input voltage to the isolated converter circuit.
